(19) United States
(12) Patent Application Publication
(10) Pub. No.: US 2011/0260874 A1
(43) Pub. Date: Oct. 27, 2011

(54) DEVICE FOR FIRE PROTECTION IN ELECTRICAL SYSTEMS

(76) Inventor: Thomas Gassmann, Hagavik (NO)

(21) Appl. No.: 12/998,635

(22) PCT Filed: Nov. 11, 2009
(86) PCT No.: PCT/NO2009/000387

§ 371 Date: Jun. 30, 2011

(30) Foreign Application Priority Data
Nov. 11, 2008 (NO) 20084768

(51) Int. Cl. G08B 17/00; B23P 11/00; F16B 2/02

(52) U.S. Cl. 340/584; 24/455; 29/428

(57) ABSTRACT

An apparatus (30, 50, 60) for protection against fire in an electrical system (10) at connection points for electrical cables (510) comprises at least one thermal element (50) which is operable to register and warn in response to increased temperature in the electrical cables (510) or in one or more electrical elements (30) whereat the cables (510) are coupled. A fire warning unit (60) is coupled in operation to the at least one thermal element (50) for sending a warning in an event that the thermal element (50) measures an increase in temperature above a temperature threshold. Use of the thermal element (60) makes in possible to detect early melting or fire.

### FIELD OF INVENTION

The present invention concerns devices for protecting against fire in electrical systems. Moreover, the invention relates to a method of installation of fire protection devices in electrical systems, especially in relation to electrical system installers who install apparatus for fire protection for customers in return for remuneration from such customers. Furthermore, the present invention concerns a method of using the device for detecting fires or risk of fire in electrical systems. The invention is, for example, relevant in relation to connection points for electrical conductors and cables where poor electrical contact can result in localized heat generation and subsequently fire. Furthermore, the invention is concerned with a clamping means to fasten said protection device for electrical systems.

### BACKGROUND OF THE INVENTION

It is well known that electrical systems give rise to fires in facilities and buildings. The reason is that a concentration in energy in the conductor network arise, and that electrical fuses for protecting against overload function first after insulation material has been damaged, for example as a consequence of fire. Electrical fuse cupboards and electrical fuse panels, or other types of connection cupboards such as a data cupboard, are known electrical installations which can be an origin for fire. Typical known causes to such fires are that a poor electrical contact arises in connections which gives rise to localized resistance points which result in warming in response to a flow of current through the points. Localized resistance can, for example, arise over a longer period of time as a consequence of corrosion resulting from dampness or water. Such warming can result in damage to insulators which can cause short circuits, electric arcs, overload and failure in elements of coupled electrical apparatus.

At points where two associated conductors are coupled together, problems can arise as a consequence that metal ages and contracts, something which can results in heating of elements whereat the conductors are coupled which thus a fire may arise.

A start of fire in such electrical fuse cabinets can have serious consequences. In addition to ruination of the fuse cabinets themselves and corresponding material damage, interruption of electrical supply can also result as a consequence. Such failures give rise to a significant proportion of fire damage in electrical facilities in industrial buildings, private residences and other buildings as well as installations such as on ships, oil platforms, power station et cetera. Undesired development of heat in cables and fuses or other components coupled thereto in fuse cabinets can result in conductors welding, melting catching fire.

It is known that smoke alarms outside fuse cabinets are able to detect such events rather late, for example firstly after an actual fire has arisen in the cabinet. To improve security, fire detectors can be mounted within the cabinet to provide an improved fire warning on account of generation of smoke being detected earlier; moreover, in this situation, earlier detection of fire is unfortunately possible, but firstly after heat generation has considerably progressed and gasses and smoke have arisen within the cabinet, and finally possibly open flames.

In a published international PCT patent application no. WO2008/044939 (Per Erik Lie, Norway), there is described a system for fire protection in electrical installations. The system is operable to detect and hinder electric fires in electrical distribution panels in private dwellings, wherein such electrical distribution panels comprise a fuse box and a main electrical distribution panel and a sub-electrical distribution panel. A main switch couples the fuse box to the main electrical distribution panel. First, second and third gas-. smoke- and heat-sensors are included in the system and are disposed in the fuse box, in the main electrical distribution panel and in the sub-electrical distribution panels. A remotely-mounted main current breaker can be activated for interrupting the current to the main electrical distribution panel in a case of fire. The system is of benefit on account of changes can be implemented in the main electrical distribution panel and the sub-electrical distribution panel, for example changes involving including extra switches and/or fuses can be implemented without a need to develop heat- or smoke alarm systems further.

It is known to monitor temperature in cables by using thermocouples. For example, there is described in a published patent no. GB 1,280, 723 use of elements which change their resistance as a function of temperature. These elements can be used for measuring cable temperatures.

### SUMMARY OF THE INVENTION

An object of the invention is to provide a fire warning apparatus for electrical systems which is more effectively able to detect fire in cables and similar, for example with regard the fuse cabinets, fuse panels and data panels.

A further object of the invention is to hinder occurrence of fires in electrical systems at an early stage, for example beneficially before fuses, conductors, switches and similar electrical elements begin to weld, melt or begin to burn and cause fires.

A further object of the invention is for early detection of fault conditions in connection boxes and fuse cabinets and thereby ensure that electrical elements are detached from the electrical power network before a fire commences.

A further object of the invention is to be able to identify electrical elements in electrical cabinets which are faulty with a result that they develop warmth and can give rise to fire.

According to a first aspect of the present invention, there is provided a device as defined in the accompanying claim 1; there is provided an apparatus for fire warning in an electrical system including coupling points for cables, characterized in that the device includes at least one thermal element which is operable to detect and warn regarding increased heating in the electrical cables, one or more electrical element whereat the cables are connected, and a fire protecting unit coupled in use to said at least one thermal element for sending warning in an event that the thermal element measures a temperature increase above a temperature threshold.

The invention is of advantage in that the thermal element is more effective at detecting a danger of fire in the electrical system.

A major advantage of the invention is that advantageous disposition and mounting of the thermal element closely to points where electrical cables are coupled, which makes it possible to detect development of warmth at an earlier stage. Thereby, a risk of actual occurrence of fire is reduced.

The apparatus is beneficially implemented such that the thermal element assumes a form of an elongate band which can be coupled in series along connection points for simultaneously monitoring a plurality of connection points. Optionally, the thermal element has a length in a range of 10 cm to 10 metres for example.

The apparatus is beneficially implemented such that the thermal element is installed in a spatial region whereat the cables are coupled to the one or more electrical elements, for detecting warming in insulating material of the cables in a vicinity whereat the cables are coupled. Surprisingly to more effective to detect occurrence of fire by utilizing the present invention in comparison solutions wherein the thermal element is moulded into the housing for fuses and similar.

The device is beneficially implemented, such that the thermal element comprises at least two mutually different metals which in use induce an electromotive potential when mutually joined, and which show a change in electromotive potential when exposed to a temperature change when used. A thermistor implementation of the thermal element is also feasible within the scope of the invention.

The device is beneficially implemented such that the thermal element is provided with a sleeve or sock as outer protection, and wherein the aforesaid loop sock is adapted to provide an electrically-isolating thermal contact with the aforesaid connection points in the electrical system.

The apparatus is beneficially implemented such that one or more clamping devices are used to establish contact between the thermal element and the cables, and wherein the one or more fastening devices press or maintain the thermal element in the vicinity of (adjacent to) the coupling points.

According to a second aspect of the invention, there is provided a fastening device for coupling a thermal element of an apparatus according to the first aspect of the invention.

The fastening device is beneficially implemented such that the aforesaid fastening device includes a clamp for detachable clamping of the thermal element to one or more of the connection points.

The fastening device is beneficially implemented such that the clamp is formed from two “L”-shaped clamp parts which are to an extent mutually moveable in a locked state and released free state, and thereby form two clamp parts adapted to provide a clamping contact to one or more coupling points. Moreover, the fastening device is implemented in such that the main part of the clamp part are coupled together via a locking device adapted to provide the aforesaid locking position between the clamp parts.

The fastening device is beneficially slidable along the cables and at least a part of the thermal element in order to clamp the thermal element to the cables in a vicinity of the coupling points.

According to a third aspect of the present invention, there is provided an apparatus kit for making installation of the apparatus possible pursuant to the first aspect of the invention.

Beneficially, the apparatus kit comprises one or more fastening devices according to the second aspect of the invention.

A method of installing an apparatus according to the first aspect of the invention is provided, wherein the method includes:
(a) laying a thermal element along coupling points for cables within a fuse facility;
(b) fastening the thermal element to at least one of the fuse elements in the fuse facility or to cables in a vicinity of where they are coupled to their respective fuse elements; and
(c) coupling the thermal element to a fire preventing unit which is operable to raise an alarm when a temperature measured in use by the thermal element exceeds a temperature threshold.

Details of the invention can be combined in other combinations whilst remaining within the scope of the present invention as defined by the appended claim set.

### DESCRIPTION OF THE DRAWINGS

Embodiments of the present invention will now be described by examples, with reference to the drawings wherein:

FIG. 1 is a schematic illustration of an electrical system which comprises a fuse cabinet with fire warning pursuant to an embodiment of the present invention;

FIG. 2 is a schematic illustration of an example of a manner in which a thermal element implemented as a string which is fastened to a number of fuses in the fuse cabinet illustrated in FIG. 1;

FIG. 3 is an alternative schematic illustration of the thermal element of FIG. 2 attached to fuses in the fuse cabinet;

FIG. 4 is a schematic illustration of a lockable clamp in side view for implementing the invention;

FIG. 5 is an illustration of details of a lock house of the lockable clamp shown in FIG. 4;

FIG. 6 is an illustration of a part of a leg from the lockable clamp of FIG. 4;

FIG. 7 is an illustration of an alternative implementation of the invention as shown in FIG. 1 with a thermal element plaited in between current cables and maintained in position with adhesive or similar;

FIG. 8 is an illustration of a further alternative implementation of the invention as shown in FIG. 1, wherein the thermal element is laid onto current cables and held in position by using clamping components;

FIG. 9 is an illustration of a clamping component of FIG. 8 as seen from various angles; and

FIG. 10 is an illustration of a further alternative implementation of the invention as shown in FIG. 1, wherein the thermal element is laid onto the current cables and maintained in position by use of press-fastening components, for example known as “Velro strip” as described in a U.S. Pat. No. 4,531,634 which is hereby incorporated by reference.

In the accompanying diagrams, an underlined number is inserted to represent an element over which the underlined number is placed or an element adjacent to the underlined number. A non-underlined number related to an element is identified by a line between the non-underlined number and the element. When a number if not underlined and is accompanied by an associated arrow, the non-underlined number is used to identify a general element towards which the arrow is pointing.

### DESCRIPTION OF EMBODIMENTS OF THE INVENTION

An aim of the present invention is to ensure improved security against fires in electrical systems.

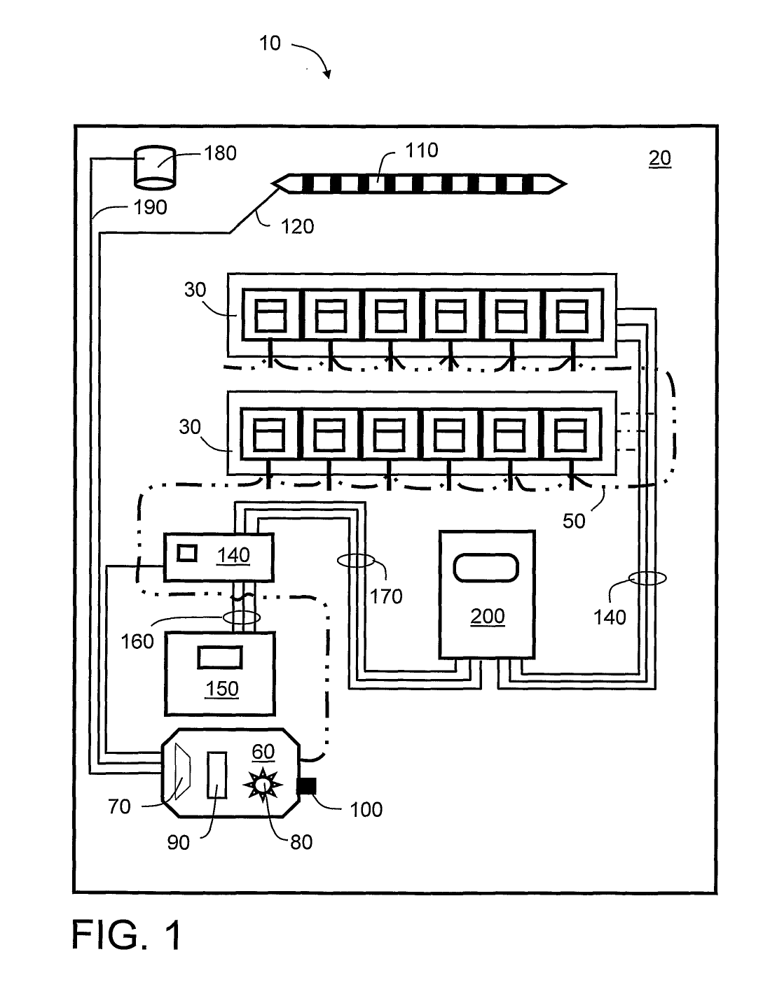

In FIG. 1, there is shown an electrical system indicated generally by 10 which comprises a fuse cabinet 20. The fuse cabinet 20 comprises a plurality of fuse elements 30 which are provided with electrical power via electrical cables 40. The fuse elements 30 are implemented in two rows. The cables 40 are coupled to a metering instrument 200 as illustrated. The metering instrument 200 measures the electricity consumption via the system 10. A thermal element 50 comprises a stretched out thermal element string or flat band which is laid in loops within the fuse cabinet 20 itself, up and around and in close contact with all elements which unintentionally can be expected to develop warmth when they are in operation, for example the fuse elements 30 and the electrical cables 40.

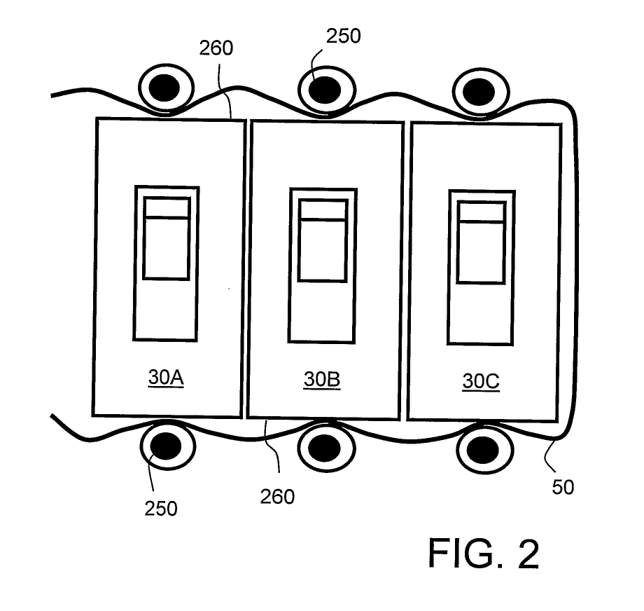

The thermal element string is beneficially arranged in a non-conductive sleeve which is able to withstand relatively high temperatures approaching 200° C. or higher; for example, the sleeve can be fabricated by employing woven fibreglass with silicone rubber and/or PVC. FIG. 1 is a schematic illustration of the string arrangement onto each fuse element 30. The string arrangement can be implemented in several different ways on each fuse element 30 as will be described in detail below. FIG. 2 is an illustration of a manner in which the thermal element 50 can form a contact with both the upper side and underside of the fuse element 30. The measuring instrument 200 is coupled via cables 170 to an earth fault breaker 140 and thereafter via cables 160 to a main fuse or input fuse 150 to the electrical power supply network. At least one of the cables 160, 170 is measured by the thermal element 50 as illustrated in FIG. 1. The system 10 comprises further a temperature measuring apparatus 60 coupled to the thermal element 50. The temperature measuring apparatus 60 includes an acoustic alarm 70, an optical alarm 80 and a temperature indicator 90. When the temperature measured by the measuring instrument 60 via the thermal element 50 in operation exceeds a first temperature threshold, an alarm is activated, for example via the indicator 80 and/or the indicator 90. Beneficially, the measuring apparatus 60 includes an information portal 100, for example an interface such as an Internet coupling and/or a wireless coupling, for providing external warning of fire and/or temperature increase.

The thermal element 50 is beneficially implemented as a flat flexible strip (a band) which includes at least one of: thermosensitive resistors, thermocouples, thermal switches (miniature bi-metallic switches), silicon temperature sensors integrated circuits and similar which are operable to generate a signal representative of temperature of the fuse elements 30. Such thermal elements are produced, for example by Minco Products Inc., Minneapolis, USA; there are several suppliers of similar types of thermal elements 50.

When a fault occurs in the electrical system 10 which develops warmth, this will very quickly be measured via the thermal element 50 which is coupled to the measuring instrument 60 which registers changes in potential in manner which is usual for thermal elements. A change in temperature will change potential in the thermal element 50 which the measuring instrument 60 interprets to be a fault condition. Alternatively, warning devices 70, 80 can be activated in a fault situation, namely when a measured temperature exceeds a temperature threshold.

A change in warmth at a point along the thermal element 50, the potential in the circuit of the thermal element 50 changes and will cause an earth failure via the earth circuit breaker 140. The change In potential is registered in the fire warning unit 60 which is coupled to earth 110 via a conductor 120, and at the same time coupled to the circuit breaker 140 and an earth conductor 130. This results in the electrical supply being switched out. The earth circuit breaker 140 is coupled to the meter 200 via conductors 170. The conductors 170 are further directed to the fuses 30. Tre-phases in the system 10 from the main fuse 150 to the fuses 30 are indicated. Alternatively, the system 10 is flexible and can also be used for a 1-phase implementation. The aforementioned system 10 is implemented such that the system 10 decouples the electrical supply in an event that the temperature at each measuring point of the thermal element 50, or within the cabinet generally, exceeds a temperature threshold, for example +70° C.

The fire protecting unit 60 can beneficially provide a local alarm warning, such as by way of the acoustic alarm 70 from a loudspeaker and/or by way of the visual alarm 80, for example a flashing light to show an alarm situation. In an embodiment of the fire alarm unit may include the temperature indicator 90 which in operation shows the temperature measured by the thermal element 50. As named above, the fire warning unit 60 includes a portal 100 for providing external warning, for example via a NC-contact, wherein it is possible to couple an alarm centre or other type of receiver; “NC” is an abbreviation for “normally closed”. The coupling and warning is beneficially implemented without potential difference, thereby being independent of provision of electrical supply. It is also envisaged that the fire warning unit 60 optionally has an integrated transmitter which is operable to send a Short Message System (SMS) message to the user's mobile telephone.

In a preferred embodiment, an even more optimal fire protection is achieved by combining the thermal element 50 in the fuse cabinet 20 with a gas and/or smoke detector 180 which is coupled to the fire alarm unit 60 via a wire 190. The smoke- and gas-detector 180, as shown in FIG. 1, disposed uppermost in the fuse cabinet 20, can comprise optical detectors, ion detectors or similar with beneficially high sensitivity for smoke and gases, and which in addition can be pre-calibrated. The detectors 180 are operable to detect smoke and/or gas, such as chlorine gas which is expelled from apparatus and cables when heat is generated and/or fire as a consequence of overload, short circuits, electrical arcs and similar and to send a signal via the wire 190 to the fire alarm unit 60 which can both put in progress external warning and interrupt electrical supply.

In FIG. 2, there is shown in greater detail a manner in which the thermal element 50 is installed, for example, in a loop along for example thee fuses 30A, 30B, 30C in the cabinet 20. It is a significant detail that the thermal element 50 forms a tight electrically-non-conductive thermal contact with the fuse elements 30. For example, it often arises that warmth and corresponding fire is caused by poor electrical contact between an electrical wire conductor and a screw in a contact block in the fuse 30 and/or corrosion at such electrical contact. For example, screws which fasten electric wires, which can loosen in use as a consequence of vibration over a longer period of use and associated poor electrical contact, often result in fire. As shown in FIG. 2, the thermal element 50 can be installed and clamped to both underside and upper side 260 of fuse elements 30.

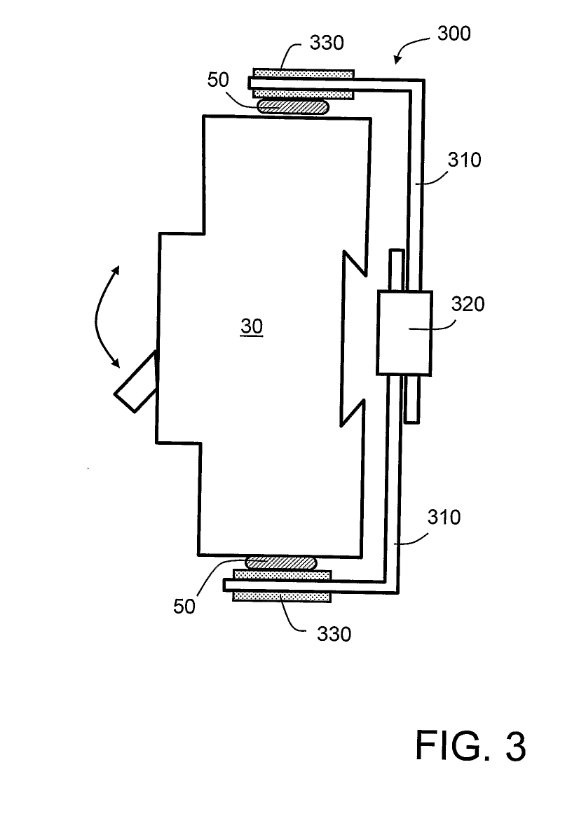

In FIG. 3, there is shown a manner in which the thermal element 50 is clamped in use both down towards the upper side and up towards the underside of the fuse element 30, namely the fuse arrangement. The thermal element 50 is clamped firmly with good thermal contact by use of a fastening clamp indicted generally by 300 pursuant to the present invention. The fastening clamp 300 is shown as a U-shaped bracket which is fastened in over the fuse element 30, such that it is clamped in onto an underside and upper side of the fuse element 30. Moreover, the fastening clamp 300 comprises a locking arrangement 320 which makes it possible to adjust the fastening clamp 300 for adapting it to various sized of the fuse elements 30 and also rendering it possible for the thermal element 50 is retained securely in position.

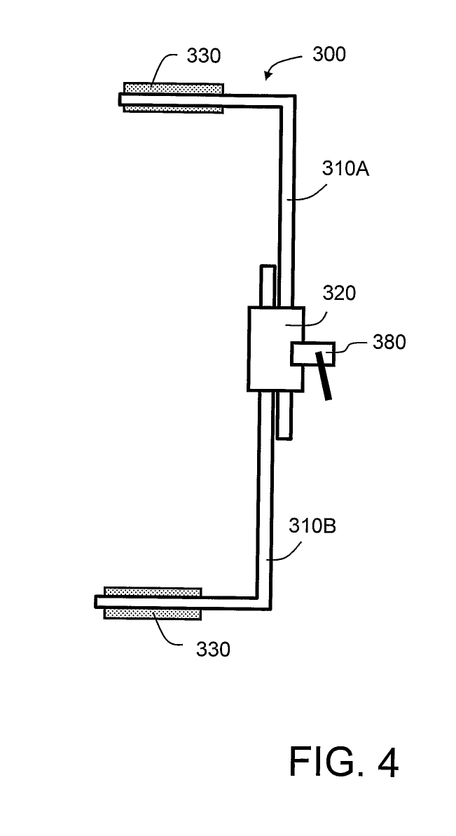

In FIG. 4 to FIG. 6, there is shown a more detailed implementation of the clamping element 300. The clamping element 300 comprises first and second L-formed bracket parts 310A, 310B respectively. The bracket parts 310A, 310B are assembled together in use such that the two provide parallel clamping leg parts equipped with soft rubber- and/or felt-sockets or sleeves 330 for providing a clamping effect against the fuse element 30 above and below as shown in FIG. 2 and FIG. 3. The L-form bracket parts 310A, 310B and their soft rubber socks or sleeves 320 can be moved towards and away from one another, namely they are moveable to a clamping position when drawn together, and to a loosened position when moved away from one another.

In order to reduce costs during manufacture, the bracket parts are beneficially manufactured from a hard plastics material, namely from a glass-filled plastics material. In order to provide a soft clamping effect from the clamp leg parts over the thermal element 50 which shall lie onto the fuse elements 30, each of them is furnished with a sleeve 350 of soft rubber and/or felt. Thereby crushing damage of the thermal element 50 is avoided.

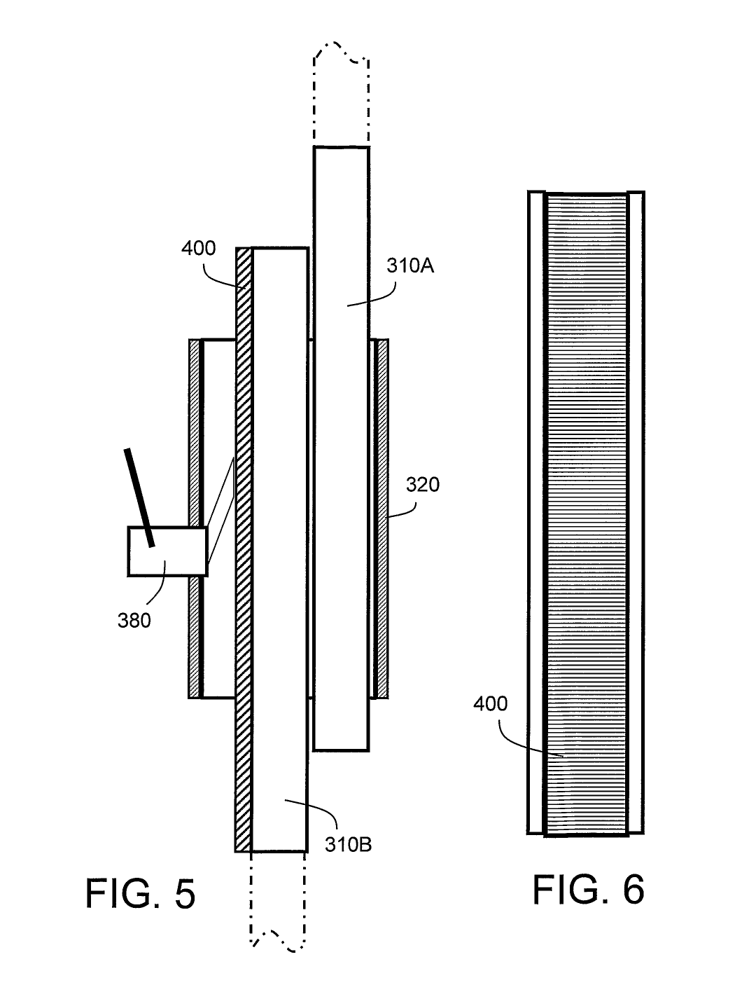

The ends of the bracket parts 310A, 310B are implemented to be attached together by passing through the lock house 320 which includes a locking arrangement 380 such that these parts can be attached to one another. As illustrated in FIG. 5, the lock house 320 is fixed and fastened to one of the long leg parts 310A, 310B whereas the other part runs adjustably through the lock house 320. The locking arrangement 380 comprises a lock plate which can be used to clamp the leg parts 310A, 310B together as shown in FIG. 5 to FIG. 6. There is used a lock tag 400 fastened to one of the leg parts 310A, 310B as shown for avoiding that the leg parts 310A, 310B loosen after installation, for example as a consequence of vibration for longer periods of times.

It is the intention that the thermal element 50 is permanently mounted to the fuse elements 30 in the cabinet 20. Moreover, with the locking mechanism according to the present invention, the thermal element 50, over the whole or over portions of its extent through the fuse elements 30, can be relatively easily loosened, in an event that it is necessary to change its path over the electrical contacts of the fuse elements 30 which are to be monitored pursuant to the present invention. There can arise a need to move or temporarily remove the thermal element 50, in an event that there is further construction work or repairs within the cabinet 20. The present invention is especially well suited for use in fuse cabinets, especially in domestic installations, to avoid dangerous evolvement of heat which can potentially give rise to fires.

The invention is advantageously adapted for early detection of faults point in fuse cabinets and thereby better ensure that the whole fuse cabinet or individual components in the fuse cabinet are decoupled from the electrical supply network before fire can occur. The fastening arrangement shown in FIG. 3 to FIG. 6 enables rapid installation of the system 10. In the present invention, there is employed a technology by way of the use of the thermal element, for example “thermocouple”, thermistor or similar. “Thermocouples” are based on two different metals inducing a potential difference when they are coupled together. The potential difference is moreover dependent upon warmth, namely temperature differences, in that one can compute the temperature difference from the induced potential. One or more conductors of the thermal element 50 which are operable to measure temperature is wound or plaited along all relevant electrical conductors which carry electrical current, and also switches and other relevant components which can potentially represent an origin for fire. All components in the fuse cabinet can be protected by way of the same lengthily deployed thermal element pursuant to the present invention.

In an embodiment of the invention, each individual component and/or individual circuit coupled individually through the thermal element 50. The benefit of this configuration with a divided fuse element 30 as shown in FIG. 1 is that not the whole of the fuse cabinet 20 must be disconnected from the electrical supply network when warmth is developed in a cable and/or circuit in the cabinet 20. Instead, it is possible to disconnect individual circuits and/or units of grouped components and/or circuits. Moreover, it can assist to identify elements and/or units where there faults have arisen in the form of the development of warmth. For example, the thermal element 50 can optionally include a row of thermal sensors along its length, and the fire warning unit 60 is beneficially provided with individual signals from each one of the thermal sensors. This makes it possible to identify immediately one or more specific fuse elements 30 whereat a fault has arisen. For example, the thermal element 50 is equipped with silicon integrated circuits which scan and multiplex temperature measurements from the thermal sensors included along the thermal element 50, to send a composite multiplexed signal to the fire alarm unit 60 representative of the temperature of the fuse elements 30.

When a malfunction occurs in electrical equipment in the cabinet 20, which develops warmth, this will be very rapidly detected by the thermal element 50. A change in temperature will change the induced potential in the circuit of the thermal element 50, and there can be implemented therefrom a break in the electrical supply via creating an Earthing fault.

When a fault is detected, the whole fuse cabinet 20, or one or more units and/or circuits are disconnected from the electrical supply network. In an alternative embodiment of the invention several co-located cabinets are simultaneously disconnected from the electrical supply network when a development of warmth, smoke and/or gas is detected in one or more of the cabinets 20.

Isolation of electrical supply from the cabinet 20 or individual components, units and/or circuit in the fuse cabinet 20 beneficially occurs by generating an Earthing fault by coupling out the Earth fault breaker 140. Alternatively, or in addition, there can be included a protection which is operable to disconnect the mains electrical supply, beneficially implemented via a relay switch and/or an over voltage breaker which interrupts power supply.

In a preferable embodiment a yet more optimal fire protection is achieved by combining temperature measurement in the fuse cabinet 20 with gas- and/or smoke detector in the fuse cabinet 20. This will give an additional safety when the thermal element 50 for one or another reason fails to function. Smoke- and/or gas measurement devices are beneficially included in the upper part or in the top of the fuse cabinet 20. Such smoke- and/or gas sensor are for example implemented as one or more optical detectors, ion detectors, electrochemical detectors ad similar. The detectors will be able the detect smoke and/or gas such as, for example, chlorine gas which is generated from apparatus and cables when they melt and/or begin to burn, for example as a consequence of overload, short circuit, electrical arcs and similar.

In an advantageous embodiment the fire warning unit 60 is coupled to a physically remote external receiver, for example via a number transmitter which warns via a short message system (SMS) a user equipped with a mobile telephone. In another advantageous embodiment of the invention, a signal is sent to a coupled fire alarm centre, a combined fire- and burglary-alarm system, other form of alarm monitoring centre. Beneficially, a warning is generated without potential and without a need for electrical supply, for example telecommunication of various types. In a beneficial embodiment of the invention, the fire alarm unit has a NC-switch (namely “normally closed”) for potential-free alarm coupling.

The fire alarm unit 60 can optionally have a temperature indicator as aforementioned which shows temperature measured by the thermal element 50 and/or a thermometer localized in a suitable location within the cabinet 20. Thereby a user can see where high temperature events occur. Moreover, this can be used for identifying a risk of danger in individual circuits, especially when these are coupled to the fire alarm unit 60 via one or more separate thermal elements 50 and by measuring the temperature and is shown separately for each unit and/or circuit.

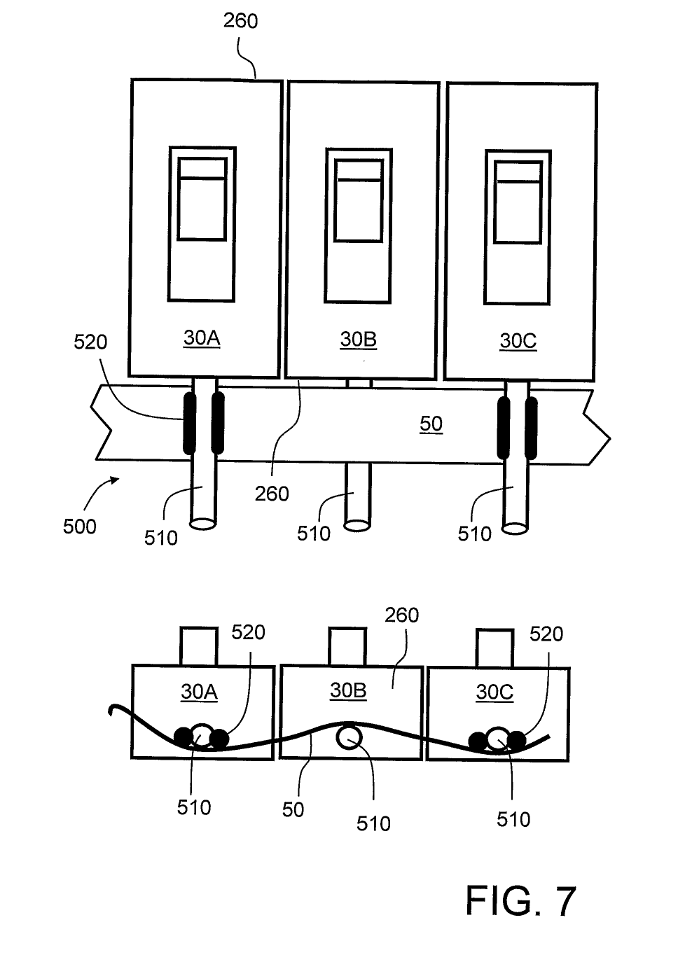

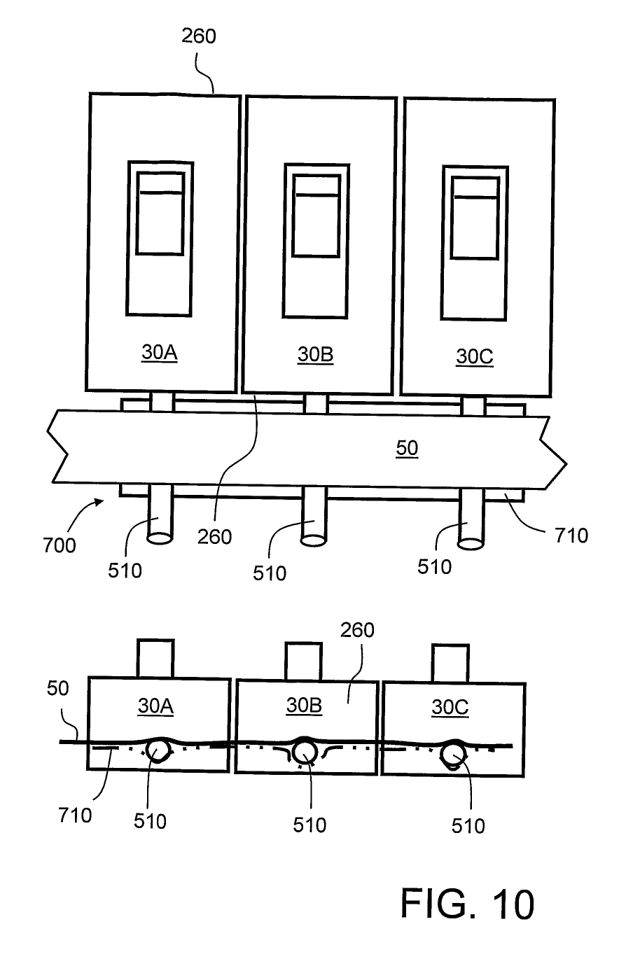

Fire situations often arises as a consequence of development of warmth where cables are clamped, for example at screws, in fuses, for example on account of a screw loosening by vibration or on account of corrosion over time. The tendency is that one of the cables 510 is clamped into the fuse 30 and is warmed up and that insulation begins to melt and catch fire. In order to best measure such a development of warmth, the thermal element 50 is mounted to the fuse elements 30 as illustrated in FIG. 7 in a plaited manner as indicated generally by 500. The thermal element 50 can have a length in a range of 10 cm to 10 metres, especially in a range of 0.5 metres to 5 metres. The thermal element 50 beneficially has a width in a range of 5 mm to 5 cm, more beneficially it has a width of 1 cm. Moreover, the thermal element 50 beneficially has a thickness in a range of 0.5 mm to 3 mm, and advantageously substantially 1 mm thickness. Beneficially, the thermal element 50 is flat as shown in FIG. 7 and is protected by a sleeve fabricated from non-combustible electrically-isolating material, for example glass fibre strengthened with silicone rubber. Optionally, after installation, glue 520 is employed for holding the thermal element 50 securely in place abutting onto the cables 510 where joined to the fuse elements 30 as illustrated in FIG. 10. The thermal element 50 can optionally be installed either before or after coupling the cables 510 to the fuse elements 30.

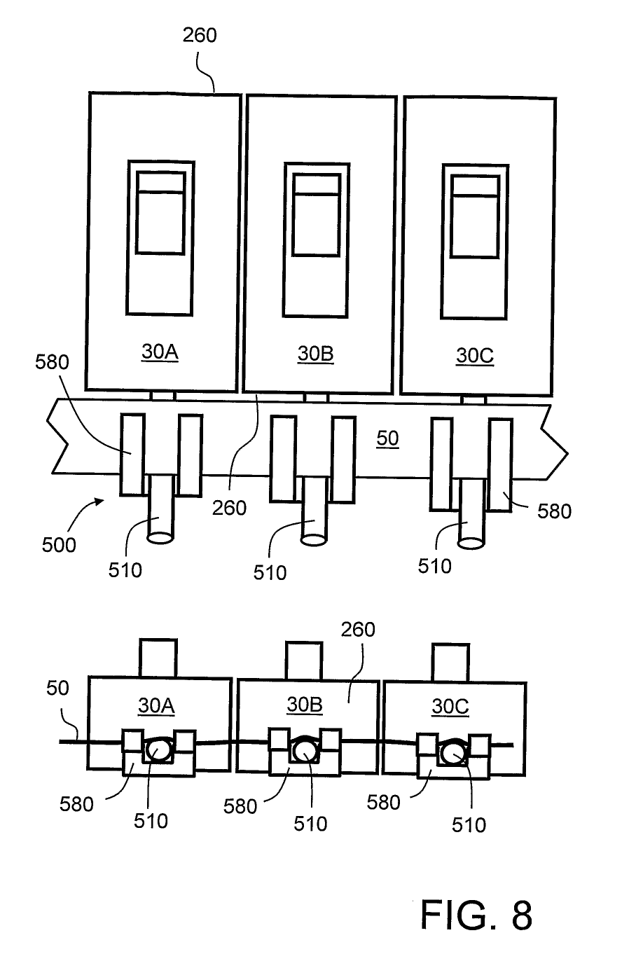

In some situations, for example when the cables 510 are already installed and coupled to the fuse elements 30 and when the thermal element 50 is relatively long, for example 5 metres, it is advantageous to use fasteners 580 for fastening the thermal element 50 against one side of the cables 510 as shown in FIG. 8 in order to avoid a need to plait the thermal element 50. Optionally, at least one side of the thermal element 50 provided with adhesive such that the thermal element 50 can be pressed into position onto the cables 510 and so thereafter fastened into position by using the fasteners 580 which can be slid up along the cables 510 and finally pushed up to fasten to both the cables 510 and the thermal element 50. The fasteners 580 can either be installed individually, or can be implemented as a series of fasteners 580 injection moulded as a component for enabling a yet more rapid installation to be achieved.

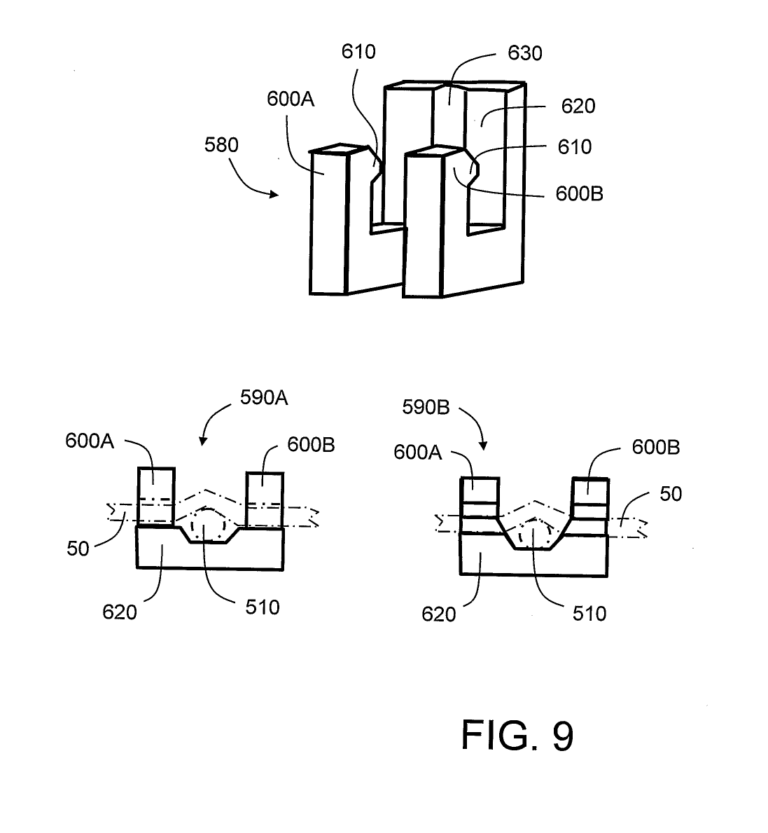

In FIG. 9, the fastener 580 is illustrated in more detail. The fastener 580 is beneficially an injection moulded component fabricated from flexible glass-filled plastics material which imparts it with low flammability. Alternatively, the fastener 580 can be fabricated from a flexible metal which is moulded within a layer of plastics material such as silicone. The fastener 580 comprises two fastening legs 600A, 600B with a projection 610 which can effectively be fastened to the thermal element 50. Moreover, the fastener 580 includes a back portion 620 with a depression 630 for receiving the cable 510. In use, the fastener 580 is brought into contact with an outer insulation of the cable 510 and is subsequently slid along the 510 until the fastening legs 600A, 600B make contact with the thermal element 50 and holds it pressed against the depression 630 in the back portion 620. The depression 630 and the back portion 620 are beneficially formed with surface roughness for improving fastening action. In order to implement the invention, several fasteners 580 together with one of more thermal elements 50 are included in an apparatus, a so-called “kit of parts”. The embodiment of the invention as illustrated in FIG. 9 is especially advantageous on account of it being susceptible to rapid installation, such that a cost of time required for installation can be reduced.

In order to make possible more rapid installation of the thermal element 50 to the cables 510 in the fuse cabinet 20, an arrangement as indicated by 700 in FIG. 10 can be used. The thermal element 50 is equipped on its underside which contacts onto the insulation of the cable 510 with a coupling arrangement implemented with miniature press-activated coupling projections, for example in a manner known as “Velcro strip” as described in U.S. Pat. No. 4,531,634 which is herewith referred to. “Velcro” is a registered trademark. During installation, these miniature coupling projections is optionally clipped away or removed by installation personnel for achieving an improved thermal contact between the thermal element 50 and insulation of the cables 510. Thereafter, a back coupling strip 710 is pressed up onto the underside of the thermal element 50 for maintaining the thermal element 50 in position on the cables 510. Optionally, some adhesive can be smeared onto the cables 510 before the thermal element 50 is placed in position for providing an even more secure mounting of the thermal element 50 onto the cables 510. Alternatively, the coupling strip 710 is cut to a suitable length with scissors, depending upon design and location of the fuse cabinet 20.

The invention as herewith described and defined in the accompanying claim set can be implemented in many different manners. For example, private persons can themselves install the safety system in their homes by using apparatus as aforementioned (“kit of parts”) pursuant to the present invention which includes all components for implementing the invention.

When an installation engineer employs the invention for a customer in return for payment, the method of implementing the invention is also possible to protect using patent rights. Moreover, components adapted for implementing the invention can also be protected via patent rights. Moreover, the thermal element is specially adapted for implementing the invention, something which can also be protected via patent rights.

The invention can be modified by way of embodiments without deviating from the scope of the invention as defined in the accompanying claims. Features of the present invention as described in the foregoing are susceptible to being combined in any combination whilst remaining within the scope of the present invention.

Phrases such as “including”, “comprising”, “incorporating”, “consisting of”, “have”, “are” used for describing the invention are intended to be construed in a non-limiting manner, namely such that for elements, components or elements which a not explicitly described can also be present. Reference to the singular is also to be construed to be a reference to the plural.

Numbers included within parentheses in the appended claim are intended to assist understanding of the claims and should not be used in any way to limit the scope of protection defined by the claims.

1. An apparatus (30, 50, 60) for providing fire protection in an electrical system (10) at coupling points of cables (510), characterized in that the apparatus (50, 60) comprises at least one thermal element (50) which is operable to detect and warn of increased warmth in the electrical cables (510), one or more electrical elements (30) where the cables (510) are coupled, and a fire warning unit (60) coupled in operation to said at least one thermal element (50) for sending warning in an event that the thermal element (50) measures a temperature rise above a temperature threshold.

2. An apparatus (30, 50, 60) as claimed in claim 1, wherein the thermal element (50) is implemented as an elongate ribbon/band which can be coupled in series along the coupling points for simultaneously monitoring a plurality of coupling points.

3. An apparatus (30, 50, 60) as claimed in claim 2, wherein the thermal element (50) has a length in a range of 10 cm to 10 metres.

4. An apparatus (30, 50, 60) as claimed in claim 2 or 3, wherein the thermal element (50) is installed in a region where the cables (510) are coupled to said one or more electrical elements (30) for detecting warming in insulating material of the cables (510) adjacent to where the cables (510) are coupled.

5. An apparatus (30, 50,60) as claimed in claim 1, 2, 3 or 4, wherein the thermal element (50) comprises at least two different metals which in use induce an electro-thermal potential when coupled together, and which exhibit a change in potential when subject to a temperature change in use.

6. An apparatus (30, 50, 60) as claimed in one of the preceding claims, wherein the thermal element (50) is equipped with a sleeve or sock as outer protection, and wherein the sleeve or sock is adapted to give an electrically insulating thermal contact with said coupling points in the electrical system (10).

7. An apparatus (30, 50, 60) as claimed in any one of the preceding claims, wherein one or more fasteners (300, 520, 580, 710) are employed to establish contact between the thermal element (50) and the cables (510), and wherein said one or more fasteners (300, 520, 580, 710) press or maintain the thermal element (50) abutting onto the coupling points.

8. A fastener (300, 520, 580, 710) for coupling a thermal element (50) of an apparatus (30, 50, 60) as claimed in any one of the preceding claims.

9. A fastener (300, 520, 580, 710) as claimed in claim 8, wherein said fastener (300) includes a bracket adapted to provide a loosenable clamping of the thermal element (50) to one or more of the coupling points.

10. A fastener (300) as claimed in claim 9, wherein the bracket comprises two L-form bracket parts which are restricted in motion in a locked position and have a freely adjustable position, and thereby form two clamping parts adapted to form a clamping contact to one or more of the coupling points.

11. A fastener (300) as claimed in claim 10, wherein the bracket parts include main portions which are adapted to be coupled together via a locking arrangement adapted to provide said locked position for the brackets.

12. A fastener (520) as claimed in claim 8 which is slidable along the cables (510) and to at least a part of the thermal element (50) for fastening the thermal element (50) to the cables (510) in a vicinity of their coupling points.

13. A kit-of-parts for making it possible to install an apparatus (30, 50, 60) as claimed in any one of claims 1 to 6.

14. A kit-of-parts as claimed in claim 13, wherein the kit-of-parts comprises one or more fasteners as claimed in any one of claims 8 to 12.

15. A method of installing an apparatus as claimed in any one of claims 1 to 6, wherein the method includes:
(a) laying a thermal element (50) along coupling points for cables (510) in a fuse facility (20);
(b) fastening the thermal element (50) to at least one of the fuses (30) in the fuse facility (20) or to cables (510) in a vicinity of where they are coupled to their respective fuse elements (30); and
(c) coupling the thermal element (50) to a fire warning unit (60) which is adapted to provide an alarm when a temperature measured in operation by the thermal element (50) exceeds a temperature threshold.
